(19) United States
(12) Patent Application Publication
(10) Pub. No.: US 2023/0209509 A1
(43) Pub. Date: Jun. 29, 2023

(54) UPLINK COMMUNICATION REPETITION IN A SINGLE SLOT USING MULTIPLE UPLINK CONTROL CHANNEL RESOURCES

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Jing SUN, San Diego, CA (US); Tao LUO, San Diego, CA (US); Peter GAAL, San Diego, CA (US); Juan MONTOJO, San Diego, CA (US); Fang YUAN, Beijing (CN); Arumugam CHENDAMARAI KANNAN, San Diego, CA (US)

(21) Appl. No.: 17/906,802

(22) PCT Filed: Apr. 6, 2020
(86) PCT No.: PCT/CN2020/083411

§ 371 Date: Sep. 20, 2022

(51) Int. Cl. H04W 72/0446; H04W 72/21; H04W 72/52; H04W 52/08

(52) U.S. Cl. CPC H04W 72/0446; H04W 72/21; H04W 72/52; H04W 52/08

(57) ABSTRACT

Various aspects of the present disclosure generally relate to wireless communication. In some aspects, a user equipment may identify multiple physical uplink control channel (PUCCH) resources in a single slot that are to be used for multiple repetitions of an uplink communication; and transmit one or more of the multiple repetitions of the uplink communication using one or more of the multiple PUCCH resources, or one or more other resources, in the same slot based at least in part on identifying the multiple PUCCH resources. Numerous other aspects are provided.

### FIELD OF THE DISCLOSURE

Aspects of the present disclosure generally relate to wireless communication and to techniques and apparatuses for uplink communication repetition in a single slot using multiple control channel resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include identifying multiple physical uplink control channel (PUCCH) resources in a single slot that are to be used for multiple repetitions of an uplink communication; and transmitting one or more of the multiple repetitions of the uplink communication using one or more of the multiple PUCCH resources, or one or more other resources, in the same slot based at least in part on identifying the multiple PUCCH resources.

In some aspects, a method of wireless communication, performed by a base station, may include determining multiple PUCCH resources in a single slot that are to be used for multiple repetitions of an uplink communication of a UE; and transmitting, to the UE, an indication of the multiple PUCCH resources to enable the UE to transmit one or more of the multiple repetitions using one or more of the multiple PUCCH resources, or one or more other resources, in the same slot.

In some aspects, a UE for wireless communication may include a memory and one or more processors operatively coupled to the memory. The memory and the one or more processors may be configured to identify multiple PUCCH resources in a single slot that are to be used for multiple repetitions of an uplink communication; and transmit one or more of the multiple repetitions of the uplink communication using one or more of the multiple PUCCH resources, or one or more other resources, in the same slot based at least in part on identifying the multiple PUCCH resources.

In some aspects, a base station for wireless communication may include a memory and one or more processors operatively coupled to the memory. The memory and the one or more processors may be configured to determine multiple PUCCH resources in a single slot that are to be used for multiple repetitions of an uplink communication of a UE; and transmit, to the UE, an indication of the multiple PUCCH resources to enable the UE to transmit one or more of the multiple repetitions using one or more of the multiple PUCCH resources, or one or more other resources, in the same slot.

In some aspects, a non-transitory computer-readable medium may store one or more instructions for wireless communication. The one or more instructions, when executed by one or more processors of a UE, may cause the one or more processors to identify multiple PUCCH resources in a single slot that are to be used for multiple repetitions of an uplink communication; and transmit one or more of the multiple repetitions of the uplink communication using one or more of the multiple PUCCH resources, or one or more other resources, in the same slot based at least in part on identifying the multiple PUCCH resources.

In some aspects, a non-transitory computer-readable medium may store one or more instructions for wireless communication. The one or more instructions, when executed by one or more processors of a base station, may cause the one or more processors to determine multiple PUCCH resources in a single slot that are to be used for multiple repetitions of an uplink communication of a UE; and transmit, to the UE, an indication of the multiple PUCCH resources to enable the UE to transmit one or more of the multiple repetitions using one or more of the multiple PUCCH resources, or one or more other resources, in the same slot.

In some aspects, an apparatus for wireless communication may include means for identifying multiple PUCCH resources in a single slot that are to be used for multiple repetitions of an uplink communication; and means for transmitting one or more of the multiple repetitions of the uplink communication using one or more of the multiple PUCCH resources, or one or more other resources, in the same slot based at least in part on identifying the multiple PUCCH resources.

In some aspects, an apparatus for wireless communication may include means for determining multiple PUCCH resources in a single slot that are to be used for multiple repetitions of an uplink communication of a UE; and means for transmitting, to the UE, an indication of the multiple PUCCH resources to enable the UE to transmit one or more of the multiple repetitions using one or more of the multiple PUCCH resources, or one or more other resources, in the same slot.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of a frame structure in a wireless communication network, in accordance with various aspects of the present disclosure.

FIG. 4 is a diagram illustrating an example of uplink communication repetition in a single slot using multiple control channel resources, in accordance with various aspects of the present disclosure.

FIG. 5 is a diagram illustrating an example of uplink communication repetition in a single slot using multiple control channel resources, in accordance with various aspects of the present disclosure.

FIG. 6 is a diagram illustrating an example of uplink communication repetition in a single slot using multiple control channel resources, in accordance with various aspects of the present disclosure.

FIG. 7 is a diagram illustrating an example process performed, for example, by a user equipment, in accordance with various aspects of the present disclosure.

FIG. 8 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

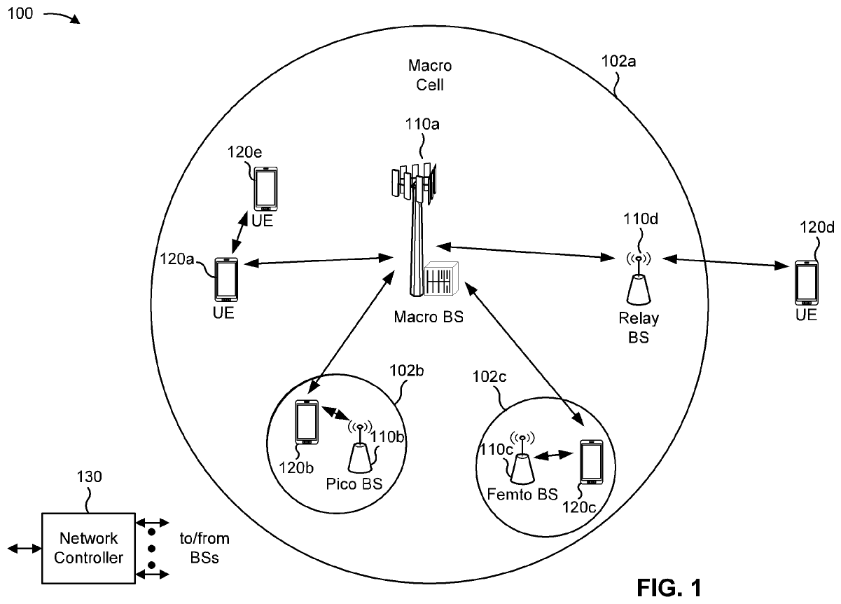

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

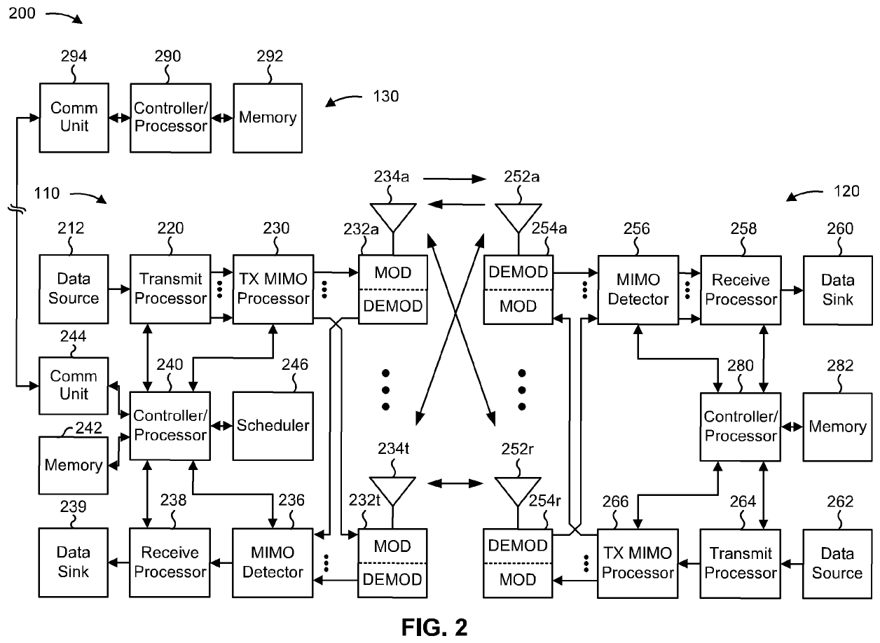

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

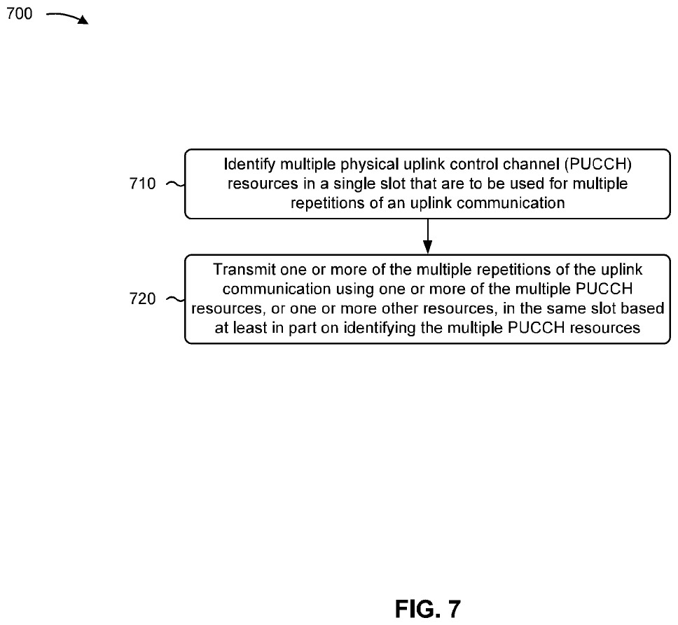

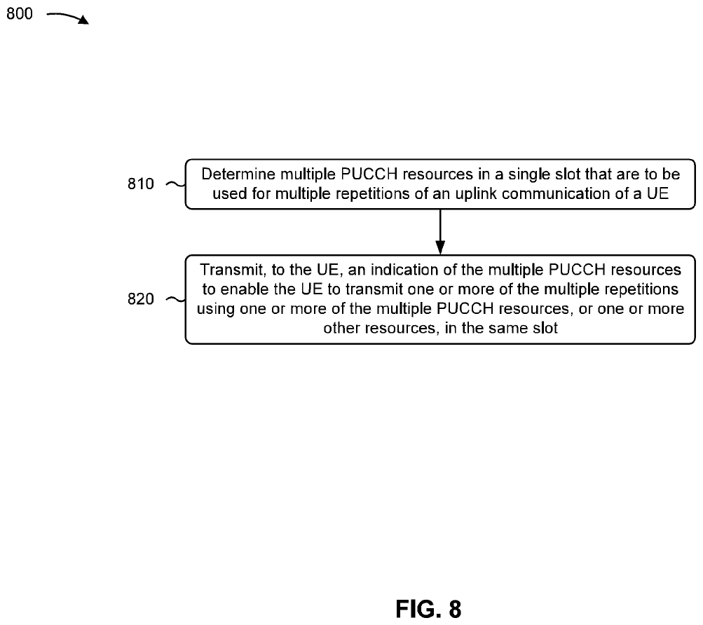

Controller/processor 240 of base station 110, controller/processor 280 of UE 120, and/or any other component(s) of FIG. 2 may perform one or more techniques associated with uplink communication repetition in a single slot using multiple control channel resources, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may perform or direct operations of, for example, process 700 of FIG. 7, process 800 of FIG. 8, and/or other processes as described herein. In some aspects, executing instructions may include running the instructions, converting the instructions, compiling the instructions, interpreting the instructions, and/or the like. A scheduler 246 may schedule UEs for data transmission on the downlink and/or uplink.

In some aspects, a UE 120 may include means for identifying multiple physical uplink control channel (PUCCH) resources in a single slot that are to be used for multiple repetitions of an uplink communication, means for transmitting one or more of the multiple repetitions of the uplink communication using one or more of the multiple PUCCH resources, or one or more other resources, in the same slot based at least in part on identifying the multiple PUCCH resources, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, a base station 110 may include means for determining multiple PUCCH resources in a single slot that are to be used for multiple repetitions of an uplink communication of a UE, means for transmitting, to the UE, an indication of the multiple PUCCH resources to enable the UE to transmit one or more of the multiple repetitions using one or more of the multiple PUCCH resources, or one or more other resources, in the same slot, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

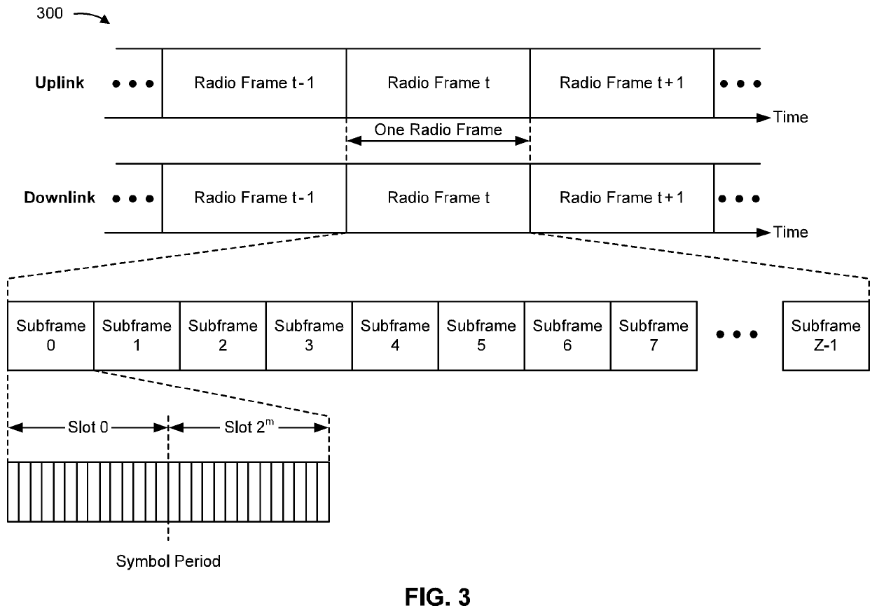

FIG. 3 is a diagram illustrating an example 300 of a frame structure in a wireless communication network, in accordance with various aspects of the present disclosure. The frame structure shown in FIG. 3 is for frequency division duplexing (FDD) in a telecommunication system, such as LTE, NR, and/or the like. The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z−1). Each subframe may have a predetermined duration (e.g., 1 ms) and may include a set of slots (e.g., 2m slots per subframe are shown in FIG. 3, where m is an index of a numerology used for a transmission, such as 0, 1, 2, 3, 4, and/or the like). Each slot may include a set of L symbol periods. For example, each slot may include fourteen symbol periods (e.g., as shown in FIG. 3), seven symbol periods, or another number of symbol periods. In a case where the subframe includes two slots (e.g., when m=1), the subframe may include 2L symbol periods, where the 2L symbol periods in each subframe may be assigned indices of 0 through 2L−1. In some aspects, a scheduling unit for the FDD may be frame-based, subframe-based, slot-based, mini-slot based, symbol-based, and/or the like.

As indicated above, FIG. 3 is provided as an example. Other examples may differ from what is described with respect to FIG. 3.

Wireless communication devices, such as UEs, BSs, TRPs, and/or the like, may communicate with each other using repetitions of communications (e.g., by transmitting the same communication multiple times). For example, for uplink communications, a BS may indicate a physical uplink control channel (PUCCH) resource to be used by a UE for multiple repetitions of an uplink communication. The BS may indicate a PUCCH resource in one slot for multiple repetitions or a PUCCH resource in multiple slots (e.g., using the same time domain resources in each slot) to be used by the UE for multiple repetitions of the uplink communication.

In some cases, it may be beneficial for a UE to communicate multiple repetitions of an uplink communication using multiple PUCCH resources that may be received by different receivers (e.g., different antennas, panels, TRPs, BSs, and/or the like), thereby improving performance of the UE's communications. Moreover, it may beneficial for the UE to communicate the multiple repetitions of the uplink communication in a single slot to reduce latency. However, the UE may not be enabled to communicate using multiple PUCCH resources for repetitions of a communication in a single slot. As a result, a diversity and/or a reliability of communications may be impaired. Some techniques and apparatuses described herein enable a UE to communicate multiple repetitions of an uplink communication using multiple PUCCH resources in a single slot.

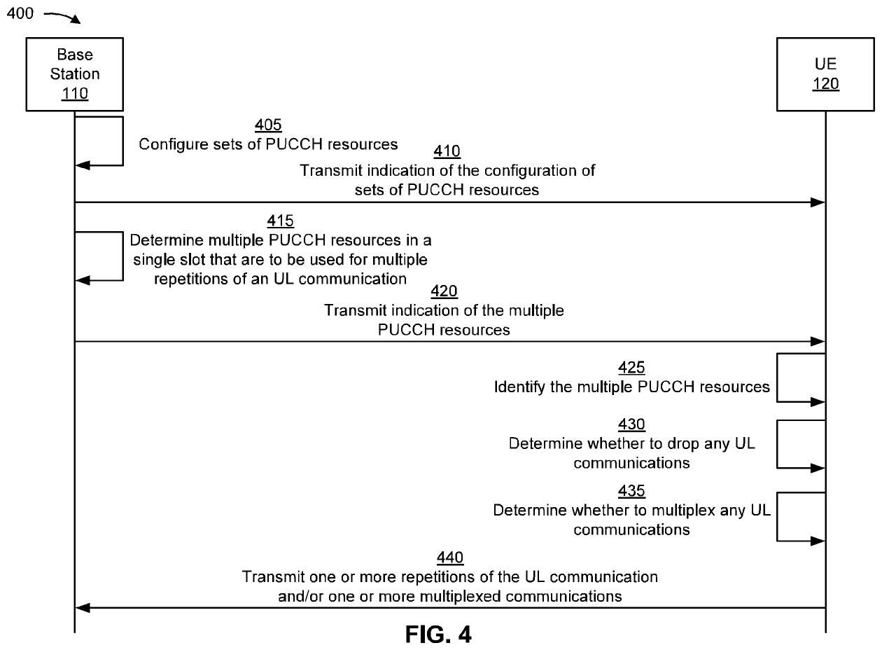

FIG. 4 is a diagram illustrating an example 400 of uplink communication repetition in a single slot using multiple control channel resources, in accordance with various aspects of the present disclosure. As shown in FIG. 4, a base station (e.g., BS 11) and a user equipment (e.g., UE 120) may communicate with one another in a wireless network (e.g., wireless network 100).

As shown by reference number 405, the BS 110 may configure a plurality of sets of PUCCH resources. The BS 110 may configure the plurality of sets of PUCCH resources using a radio resource control (RRC) protocol. For example, in some aspects, the BS 110 may configure four sets of PUCCH resources. Each set of PUCCH resources may be configured with a resource set identifier and a maximum payload size of an uplink communication for the one or more PUCCH resources included in the set of PUCCH resources.

The plurality of sets of PUCCH resources may be configured to indicate one or more PUCCH resource clusters. A PUCCH resource cluster may indicate one or more PUCCH resources (e.g., a PUCCH resource cluster may identify one PUCCH resource, two PUCCH resources, three PUCCH resources, and/or the like). Each PUCCH resource of the one or more PUCCH resources may be associated with particular resources (e.g., a quantity of resource blocks, a quantity of symbols, and/or the like). In some aspects, the one or more PUCCH resources indicated by the PUCCH resource cluster are in the same slot.

In some aspects, each set of PUCCH resources may indicate a maximum quantity of PUCCH resource clusters (e.g., maximum of 8 PUCCH resource clusters). In some aspects, one set of the one or more sets of PUCCH resources may have a higher maximum quantity of PUCCH resource clusters (e.g., a maximum of 32 PUCCH resource clusters) than all other sets of PUCCH resources (e.g., maximum of 8 PUCCH resource clusters).

As shown by reference number 410, the BS 110 may transmit an indication of the configuration of the plurality of sets of PUCCH resources. For example, the configuration of the plurality of sets of PUCCH resources may be an RRC configuration. The BS 110 may transmit the indication of the configuration of the plurality of sets of PUCCH resources using an RRC protocol.

As shown by reference number 415, the BS 110 may determine multiple PUCCH resources in a single slot that are to be used for multiple repetitions of an uplink communication by the UE 120. In some aspects, the multiple PUCCH resources may not overlap in a time domain (e.g., the multiple PUCCH resources may be time division multiplexed). In some aspects, the multiple PUCCH resources may overlap (e.g., a partial overlap, a full overlap, and/or the like) in a time domain (e.g., the multiple PUCCH resources may be frequency division multiplexed).

In some aspects, the uplink communication may be an uplink communication that is scheduled by a downlink communication (e.g., scheduled by downlink control information (DCI) indicated in a downlink communication). For example, the uplink communication may be a channel state information (CSI) communication, a hybrid automatic repeat request acknowledgement (HARQ-ACK) communication, a scheduling request (SR) communication, and/or the like. In some aspects, the uplink communication occurs periodically (e.g., without being scheduled by a downlink communication).

As shown by reference number 420, the BS 110 may transmit an indication of the multiple PUCCH resources. The indication of the multiple PUCCH resources may enable the UE 120 to transmit multiple repetitions of an uplink communication using one or more of the multiple PUCCH resources, or one or more other resources (e.g., if the UE 120 performs any multiplexing, as described herein), in the same slot. In some aspects, the indication of the multiple PUCCH resources may be included in a downlink communication that schedules the multiple repetitions of the uplink communication. For example, a DCI that schedules PDSCH (e.g. DCI formats 1_0, 1_1, 1_2) can also schedule HARQ-Ack transmission for acknowledgment of the scheduled PDSCH. In some aspects, the indication of the multiple PUCCH resources may be indicated in an RRC configuration (e.g., in the case of a periodic uplink communication).

In some aspects, the downlink communication that includes the indication of the multiple PUCCH resources and schedules the uplink communication may include a timing indicator, a PUCCH resource indicator (PRI), and/or the like. In some aspects, the downlink communication may be associated with a control resource set (CORESET). The CORESET may include a quantity of control channel element indexes.

As shown by reference number 425, the UE 120 may identify the multiple PUCCH resources in a single slot that are to be used for multiple repetitions of the uplink communication. For example, the UE 120 may identify the multiple PUCCH resources based at least in part on the indication of the multiple PUCCH resources received by the UE 120.

The UE 120 may identify a set of PUCCH resources from the plurality of sets of PUCCH resources configured by the BS 110 based at least in part on a payload size of the uplink communication. For example, the UE 120 may compare the payload size of the uplink communication to the maximum payload size associated with each set of the plurality of sets of PUCCH resources. In some aspects, the payload size of the uplink communication may be a payload size of the uplink control information (UCI) of the uplink communication. The UE may identify the set of PUCCH resources from the plurality of sets of PUCCH resources based at least in part on the comparison of the payload size of the uplink communication to the maximum payload size (e.g., based at least in part on the payload size of the uplink communication being less than the maximum payload size of the set of PUCCH resources). In some aspects, the payload size of the uplink communication may be the payload size of the uplink communication after the UE 120 performs a multiplexing operation, as described below.

In some aspects, the UE 120 may identify a PUCCH resource cluster from one or more PUCCH resource clusters indicated by the set of PUCCH resources based at least in part on the PUCCH resource indicator (PRI) received in the downlink communication that scheduled the uplink communication. In some aspects, the PRI may be capable of indicating the same quantity of values as the quantity of resource clusters indicated by the set of PUCCH resources. For example, the set of PUCCH resources may indicate 8 PUCCH resource clusters. The size of the PRI may be 3 bits, such that the PRI is capable of indicating 8 values. In that case, the UE 120 may identify the PUCCH resource cluster based at least in part on the PRI value.

In some aspects, the set of PUCCH resources may indicate a higher quantity of resource clusters than the quantity of values the PRI is capable of indicating (e.g., the set of PUCCH resources may indicate 32 PUCCH resource clusters and the PRI may be capable of indicating 8 values). In that case, the UE 120 may identify the PUCCH resource cluster based at least in part on at least one of the PRI value, a first control channel element (CCE) index of the downlink communication indicating the PRI, or the quantity of CCEs included in the CORESET in which the downlink communication indicating the PRI is received by the UE 120. For example, the PUCCH resource cluster may be derived using an equation that utilizes the PRI value, the first CCE index of the downlink communication, and the quantity of CCEs included in the CORESET.

In some aspects, the PUCCH resource cluster may indicate multiple PUCCH resources in a single slot. The UE 120 may identify the slot based at least in part on the timing indicator indicated in the downlink communication that schedules the uplink communication (e.g., the timing indicator may indicate that the slot is a quantity of slots after the downlink communication is received). If the UE 120 determines that the PUCCH resource cluster indicates multiple PUCCH resources, the UE 120 may transmit repetitions of the uplink communication in each PUCCH resource indicated in the PUCCH resource cluster. For example, if the PUCCH resource cluster indicates a first PUCCH resource and a second PUCCH resource, the UE 120 may schedule a first repetition of the uplink communication using the first PUCCH resource and a second repetition of the uplink communication using the second PUCCH resource.

In some aspects, the multiple repetitions of the uplink communication may use different spatial relations (e.g., different beams, different power control parameters, and/or the like). For example, the BS 110 may transmit an activation command (e.g., via a medium access control control element (MAC-CE)) to the UE 120 to activate a first spatial relation for a first PUCCH resource of the multiple PUCCH resources and to activate a second spatial relation for a second PUCCH resource of the multiple PUCCH resources.

In some aspects, the multiple PUCCH resources may be activated with spatial relations having different closed loop index values. The UE 120 may apply a transmit power control (TPC) command received in the downlink communication that schedules the uplink communication to the different closed loop index values. For example, the UE 120 may identify a first PUCCH resource of the multiple PUCCH resources having a first closed loop index value and a second PUCCH resource of the multiple PUCCH resources having a second closed loop index value. The UE may apply the TPC command to the first closed loop index value and the second closed loop index value. In some aspects, the UE 120 may apply the TPC command to only the first closed loop index value.

In some aspects, the BS 110 may configure the DCI of the downlink communication that schedules the uplink communication to indicate multiple TPC commands. For example, the downlink communication may indicate a first TPC command to be applied to the first closed loop index value and a second TPC command to be applied to the second closed loop index value. The BS 110 may configure respective fields in the DCI for each TPC command. In some aspects, the BS 110 may configure a single field in the DCI that indicates multiple TPC commands (e.g., the first TPC command and the second TPC command).

As shown in FIG. 4, and by reference number 430, the UE 120 may determine whether to drop one or more of the multiple repetitions of the uplink communication based at least in part on a determination that one or more of the multiple PUCCH resources associated with the uplink communication overlaps in a time domain with at least one other PUCCH resource of a different uplink communication. For example, the UE 120 may determine a priority associated with each type of uplink communication the UE 120 is capable of transmitting. In some aspects, the priority of uplink communication types may be (from highest priority to lowest priority): HARQ-ACK>SR>CSI. In some aspects, CSI communications may include higher priority CSI communications and lower priority CSI communications. In that case, the priority of uplink communication types may be (from highest priority to lowest priority): HARQ-ACK>SR>higher priority CSI>lower priority CSI.

In some aspects, the UE 120 may determine whether to drop one or more of the multiple repetitions of the uplink communication based at least in part on comparing the uplink communication type of the uplink communication to the uplink communication type of the different uplink communication. In some aspects, the UE 120 may drop the uplink communication (e.g., the uplink communication or the different uplink communication) with the lower priority uplink communication type. For example, if the repetitions of the uplink communication are SR communications and the different communication is a HARQ-ACK communication, the UE 120 may drop the repetitions of the uplink communication that overlap in the time domain with the at least one other PUCCH resource of the different uplink communication. In some aspects, if one or more repetitions of the uplink communication do not overlap in the time domain with the at least one other PUCCH resource of the different uplink communication, the UE 120 may not drop the non-overlapping repetitions of the uplink communication.

In some aspects, the UE 120 may determine that the uplink communication and the different uplink communication have the same uplink communication type. In that case, the UE 120 may compare a starting time of the one or more of the multiple repetitions of the uplink communication to a starting time of the different uplink communication. The starting time of the one or more of the multiple repetitions of the uplink communication may be determined based at least in part on the starting time of the repetition that overlaps with the different uplink communication or based at least in part on the starting time of the first repetition of the multiple repetitions of the uplink communication. In some aspects, the UE 120 may drop the uplink communication (e.g., the uplink communication or the different uplink communication) with the later starting time.

In some aspects, when the uplink communication and the different uplink communication have the same uplink communication type, the UE 120 may compare a quantity of repetitions of the multiple repetitions of the uplink communication in the slot to a quantity of repetitions of the different uplink communication in the slot. In some aspects, the quantity of repetitions of the multiple repetitions of the uplink communication may be a total quantity of repetitions or a quantity of repetitions that overlap with the different uplink communication in the time domain. In some aspects, the UE 120 may drop the uplink communication (e.g., the uplink communication or the different uplink communication) with the greater quantity of repetitions in the slot. In some aspects, the UE 120 may drop the uplink communication (e.g., the uplink communication or the different uplink communication) with the lower quantity of repetitions in the slot.

In some aspects, the UE 120 may determine that one or more of the multiple PUCCH resources overlaps in a time domain with at least one physical uplink shared channel (PUSCH) resource of an associated different uplink communication. The UE 120 may drop the different uplink communication based at least in part on determining that one or more of the multiple PUCCH resources overlaps in the time domain with the at least one PUSCH resource.

As shown by reference number 435, the UE 120 may determine whether to multiplex one or more of the multiple repetitions of the uplink communication with one or more different uplink communications, based at least in part on a determination that the one or more different uplink communications are scheduled in one or more resources that overlap in a time domain with at least one of the multiple PUCCH resources. In some aspects, the UE 120 may determine that the one or more resources that overlap in the time domain with at least one of the multiple PUCCH resources are one or more PUCCH resources. The UE 120 may multiplex the uplink communication with the one or more different uplink communications based at least in part on determining that the one or more resources that overlap in the time domain with at least one of the multiple PUCCH resources are PUCCH resources. As a result, all repetitions of the uplink communication may include the payload of the uplink communication and the different uplink communication (e.g., may include a UCI of the uplink communication and a UCI of the different uplink communication). The UE 120 may determine new PUCCH resources (which may or may not be the same as the multiple PUCCH resources originally identified) using the new payload size of the multiplexed PUCCH communication in a similar manner as described above (e.g., by identifying a PUCCH resource cluster from an identified set of PUCCH resources).

In some aspects, the UE 120 may determine that the one or more resources that overlap in a time domain with at least one of the multiple PUCCH resources are one or more resources for a PUSCH transmission. In some aspects, the UE 120 may determine that the PUSCH transmission includes multiple PUSCH repetitions. In some aspects, the UE 120 may multiplex the uplink communication (e.g., all repetitions of the uplink communication) with the multiple PUSCH repetitions based at least in part on determining that the PUSCH transmission includes multiple PUSCH repetitions. In some aspects, the UE 120 may multiplex the uplink communication with the one or more PUSCH repetitions that overlap in the time domain with at least one of the multiple PUCCH resources based at least in part on determining that the PUSCH transmission includes multiple PUSCH repetitions (e.g., such that only the overlapping PUSCH transmission includes the payload of the uplink communication (e.g., the UCI of the uplink communication)).

In some aspects, the UE 120 may drop the one or more of the multiple repetitions of the uplink communication (e.g., all repetitions of the uplink communication) based at least in part on determining that the PUSCH transmission includes multiple PUSCH repetitions. In some aspects, the UE 120 may drop the one or more repetitions of the uplink communication associated with the at least one of the multiple PUCCH resources that overlap in the time domain with the one or more PUSCH repetitions based at least in part on determining that the PUSCH transmission includes multiple PUSCH repetitions.

As shown by reference number 440, the UE 120 may transmit, to the B S 110, the one or more repetitions of the uplink communication and/or the one or more multiplexed communications in the single slot. For example, the UE 120 may transmit the multiple repetitions of the uplink communication using the multiple PUCCH resources in the single slot after determining whether to drop or multiplex one or more of the multiple repetitions. In some aspects, the UE 120 may transmit one or more repetitions of the uplink communication in the single slot using resources that are different than the multiple PUCCH resources (e.g., after performing a multiplexing operation).

As indicated above, FIG. 4 is provided as an example. Other examples may differ from what is described with respect to FIG. 4.

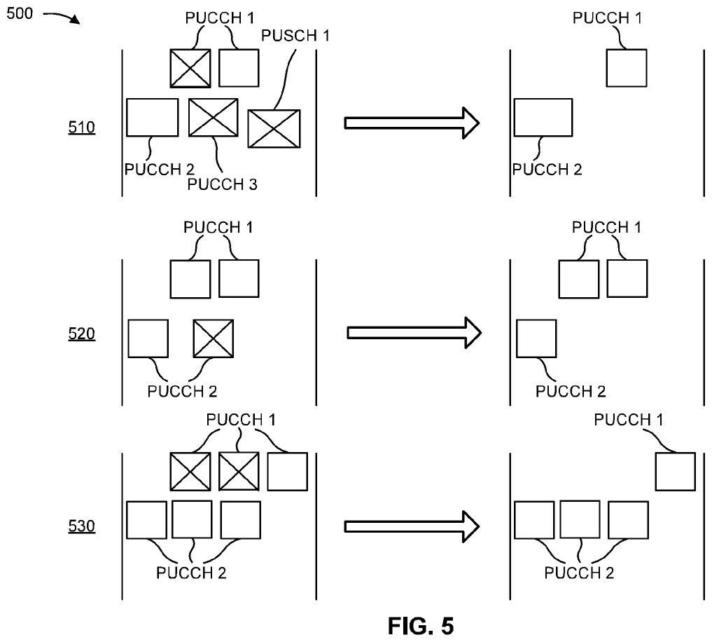

FIG. 5 is a diagram illustrating an example 500 of uplink communication repetition in a single slot using multiple control channel resources, in accordance with various aspects of the present disclosure. As shown, a transmission timeline for an uplink may include one or more slots, such as a first slot (e.g., slot 510), a second slot (e.g., slot 520), and a third slot (e.g., slot 530). Slot 510, slot 520, and/or slot 530 may be different slots in the same transmission timeline for an uplink. In some aspects, slot 510, slot 520, and/or slot 530 may represent the same slot in different transmission timelines for an uplink. A block in slot 510, slot 520, and/or slot 530 may represent one resource (e.g., a PUCCH resource, a resource for a PUSCH transmission, and/or the like).

In some aspects, a user equipment (e.g., UE 120) may compare the uplink communication types of the uplink communications in each slot to determine which (if any) uplink communications to drop. In some aspects, the UE 120 may determine which (if any) uplink communications to drop in a similar manner as described above with respect to FIG. 4. Slot 510, slot 520, and slot 530 are provided merely as examples. Other slots may include more uplink communications, less uplink communications, different uplink communications, and/or the like.

For example, as shown in slot 510, the UE 120 may identify multiple (e.g., two) repetitions of an uplink communication (e.g., PUCCH 1) using multiple (e.g., two) PUCCH resources in slot 510. The UE may identify that PUCCH 1 is a scheduling request (SR) communication. The UE 120 may identify a second uplink communication (e.g., PUCCH 2) that is a hybrid automatic repeat request acknowledgement (HARQ-ACK) communication. The UE 120 may identify a third uplink communication (e.g., PUCCH 3) that is a channel state information (CSI) communication. The UE 120 may identify an uplink data transmission (e.g., PUSCH 1).

The UE 120 may determine that a first repetition of PUCCH 1 should be dropped based at least in part on the PUCCH resource of the first repetition of PUCCH 1 overlapping in a time domain with a PUCCH resource of PUCCH 2 and based at least in part on the uplink communication type of PUCCH 2 (e.g., HARQ-ACK) having a higher priority than the uplink communication type of PUCCH 1 (e.g., SR). The UE 120 may determine that PUCCH 3 should be dropped based at least in part on the PUCCH resource of PUCCH 3 overlapping in a time domain with at least one of the repetitions of PUCCH 1 and based at least in part on the uplink communication type of PUCCH 1 (e.g., SR) having a higher priority than the uplink communication type of PUCCH 3 (e.g., CSI). The UE 120 may determine that PUSCH 1 should be dropped based at least in part on a resource of PUSCH 1 overlapping in a time domain with at least one of the repetitions of PUCCH 1 and based at least in part on determining that the resource of PUSCH 1 is to be used for a PUSCH transmission. As a result, the UE 120, after determining which uplink communications should be dropped, may transmit PUCCH 2 and the second repetition of PUCCH 1 in slot 510 (e.g., as shown after the top arrow in FIG. 5).

As shown in slot 520, the UE 120 may identify multiple (e.g., two) repetitions of an uplink communication (e.g., PUCCH 1) using multiple (e.g., two) PUCCH resources in slot 520. The UE may identify that PUCCH 1 is a HARQ-ACK communication. The UE 120 may identify multiple (e.g., two) repetitions of another uplink communication (e.g., PUCCH 2) using multiple (e.g., two) PUCCH resources in slot 520. The UE 120 may identify that PUCCH 2 is an SR communication. The UE 120 may determine that a second repetition of PUCCH 2 should be dropped based at least in part on the PUCCH resource of the second repetition of PUCCH 2 overlapping in a time domain with at least one of the repetitions of PUCCH 1 and based at least in part on the uplink communication type of PUCCH 1 (e.g., HARQ-ACK) having a higher priority than the uplink communication type of PUCCH 2 (e.g., SR). The UE 120 may determine that the first repetition of PUCCH 2 should not be dropped based at least in part on the PUCCH resource of the first repetition of PUCCH 2 not overlapping in a time domain with at least one of the PUCCH resources of one or more of the repetitions of PUCCH 1 (or any other PUCCH resource of another uplink communication). As a result, the UE 120, after determining which uplink communications should be dropped, may transmit the first repetition of PUCCH 2 and both repetitions of PUCCH 1 in slot 520 (e.g., as shown after the middle arrow in FIG. 5).

As shown in slot 530, the UE 120 may identify multiple (e.g., three) repetitions of an uplink communication (e.g., PUCCH 1) using multiple (e.g., three) PUCCH resources in slot 530. The UE may identify that PUCCH 1 is a CSI communication. The UE 120 may identify multiple (e.g., three) repetitions of another uplink communication (e.g., PUCCH 2) using multiple (e.g., three) PUCCH resources in slot 530. The UE 120 may identify that PUCCH 2 is an SR communication. The UE 120 may determine that the first two repetitions of PUCCH 1 should be dropped based at least in part on the PUCCH resources of the first two repetitions of PUCCH 1 overlapping in a time domain with at least one PUCCH resource of one or more repetitions of PUCCH 2 and based at least in part on the uplink communication type of PUCCH 2 (e.g., SR) having a higher priority than the uplink communication type of PUCCH 1 (e.g., CSI). The UE 120 may determine that the last repetition of PUCCH 1 should not be dropped based at least in part on the PUCCH resource of the last repetition of PUCCH 1 not overlapping in a time domain with at least one of the PUCCH resources of one or more of the repetitions of PUCCH 2 (or any other PUCCH resource of an uplink communication). As a result, the UE 120, after determining which uplink communications should be dropped, may transmit all repetitions of PUCCH 2 and the last repetition of PUCCH 1 in slot 530 (e.g., as shown after the bottom arrow in FIG. 5).

As indicated above, FIG. 5 is provided as an example. Other examples may differ from what is described with respect to FIG. 5.

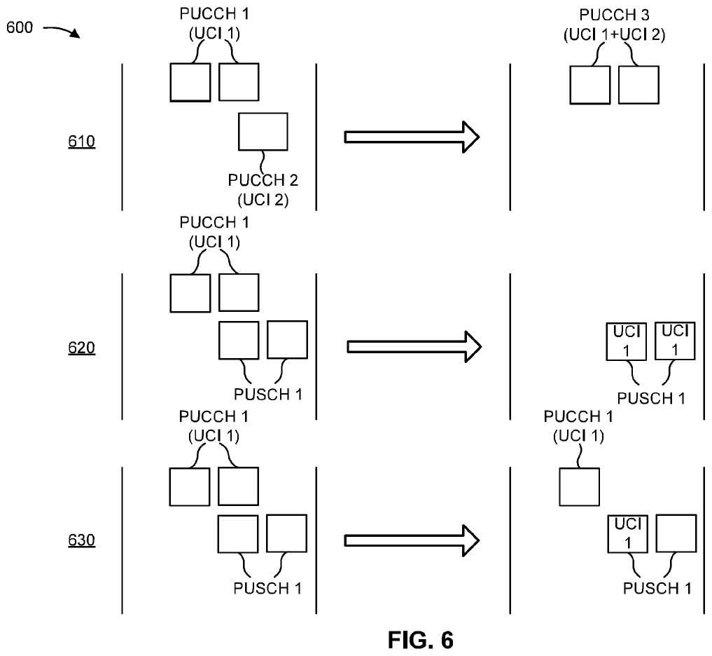

FIG. 6 is a diagram illustrating an example 600 of uplink communication repetition in a single slot using multiple control channel resources, in accordance with various aspects of the present disclosure. As shown, a transmission timeline for an uplink may include one or more slots, such as a first slot (e.g., slot 610), a second slot (e.g., slot 620), and a third slot (e.g., slot 630). Slot 610, slot 620, and/or slot 630 may be different slots in the same transmission timeline for an uplink. In some aspects, slot 610, slot 620, and/or slot 630 may represent the same slot in different transmission timelines for an uplink. A block in slot 610, slot 620, and/or slot 630 may represent one resource (e.g., a PUCCH resource, a resource for a PUSCH transmission, and/or the like).

In some aspects, a user equipment (e.g., UE 120) may determine whether PUCCH resources of different uplink communications in each slot overlap in a time domain to determine which (if any) uplink communications to multiplex. In some aspects, the UE 120 may determine which (if any) uplink communications to multiplex in a similar manner as described above with respect to FIG. 4. Slot 610, slot 620, and/or slot 630 are provided merely as examples. Other slots may include more uplink communications, less uplink communications, different uplink communication, and/or the like.

For example, as shown in slot 610, the UE 120 may identify multiple (e.g., two) repetitions of an uplink communication (e.g., PUCCH 1) using multiple (e.g., two) PUCCH resources in slot 610. The UE 120 may determine that the payload of PUCCH 1 is uplink control information (UCI) 1. The UE 120 may identify a second uplink communication (e.g., PUCCH 2) with a payload of UCI 2. The UE 120 may determine that PUCCH 1 and PUCCH 2 should be multiplexed based at least in part on determining that the PUCCH resource of PUCCH 2 overlaps in a time domain with at least one PUCCH resource of the multiple repetitions of PUCCH 1. As a result, the UE 120, after determining which uplink communications should be multiplexed (and multiplexing the uplink communications) may transmit both repetitions of PUCCH 1 (e.g., as shown after the top arrow in FIG. 6). In some aspects, the payload of all of the multiple repetitions of PUCCH 1 after multiplexing may include UCI 1 and UCI 2 (e.g., as all repetitions of an uplink communication may have the same payload). In some aspects, the PUCCH resources of the multiple repetitions of PUCCH 1 may change after multiplexing (e.g., based at least in part on the payload of PUCCH 1 changing, as described above with respect to FIG. 4).

As shown in slot 620, the UE 120 may identify multiple (e.g., two) repetitions of an uplink communication (e.g., PUCCH 1) using multiple (e.g., two) PUCCH resources in slot 620. The UE 120 may determine that the payload of PUCCH 1 is UCI 1. The UE 120 may identify multiple (e.g., two) repetitions of a PUSCH transmission (e.g., PUSCH 1) using multiple (e.g., two) PUSCH resources (multiple sets of consecutive OFDM symbols for transmission of the multiple PUSCH repetitions) in slot 620. The UE may determine that PUSCH 1 should not be dropped based at least in part on PUSCH 1 having multiple repetitions. The UE 120 may determine that PUCCH 1 and PUSCH 1 should be multiplexed based at least in part on determining that at least one PUCCH resource of the multiple repetitions of PUCCH 1 overlaps in the time domain with at least one symbol of any of the multiple repetitions of PUSCH 1. As a result, the UE 120, after determining which uplink communications should be multiplexed (and multiplexing the uplink communications) may transmit both repetitions of PUSCH 1 (e.g., as shown after the middle arrow in FIG. 6). In some aspects, the payload of all repetitions of PUSCH 1 after multiplexing may include UCI 1 (e.g., from PUCCH 1).

In some aspects, as shown by slot 630, the UE 120 may determine that the second repetition of PUCCH 1 should be multiplexed with the first repetition of PUSCH 1 based at least in part the PUCCH resource of the second repetition of PUCCH 1 overlaps in the time domain with at least one symbol of the first repetition of PUSCH 1. As a result, the UE 120, after determining which uplink communications should be multiplexed (and multiplexing the uplink communications) may transmit the first repetition of PUCCH 1 (including UCI 1) and both repetitions of PUSCH 1 (e.g., as shown after the bottom arrow in FIG. 6). The first repetition of PUSCH 1, after multiplexing, may include UCI 1.

In some aspects, the UE 120 may determine that all repetitions of PUCCH 1 should be dropped based at least in part on one or more PUCCH resources of the multiple repetitions of PUCCH 1 overlapping in the time domain with one or more resources of the multiple repetitions of PUSCH 1. In some aspects, the UE 120 may determine that the overlapping repetitions of PUCCH 1 should be dropped (e.g., the repetitions of PUCCH 1 associated with PUCCH resources that overlap in the time domain with one or more resources of the multiple repetitions of PUSCH 1).

As indicated above, FIG. 6 is provided as an example. Other examples may differ from what is described with respect to FIG. 6.

FIG. 7 is a diagram illustrating an example process 700 performed, for example, by a user equipment, in accordance with various aspects of the present disclosure. Example process 700 is an example where the user equipment (e.g., user equipment 120 and/or the like) performs operations associated with uplink communication repetition in a single slot using multiple uplink control channel resources.

As shown in FIG. 7, in some aspects, process 700 may include identifying multiple PUCCH resources in a single slot that are to be used for multiple repetitions of an uplink communication (block 710). For example, the user equipment (e.g., using receive processor 258, transmit processor 264, controller/processor 280, memory 282, and/or the like) may identify multiple PUCCH resources in a single slot that are to be used for multiple repetitions of an uplink communication, as described above.

As further shown in FIG. 7, in some aspects, process 700 may include transmitting one or more of the multiple repetitions of the uplink communication using one or more of the multiple PUCCH resources, or one or more other resources, in the same slot based at least in part on identifying the multiple PUCCH resources (block 720). For example, the user equipment (e.g., using receive processor 258, transmit processor 264, controller/processor 280, memory 282, and/or the like) may transmit one or more of the multiple repetitions of the uplink communication using one or more of the multiple PUCCH resources, or one or more other resources, in the same slot based at least in part on identifying the multiple PUCCH resources, as described above.

Process 700 may include additional aspects, such as any single aspect or any combination of aspects described below and/or in connection with one or more other processes described elsewhere herein.

In a first aspect, the multiple PUCCH resources are time division multiplexed.

In a second aspect, alone or in combination with the first aspect, the multiple PUCCH resources overlap in a time domain.

In a third aspect, alone or in combination with one or more of the first and second aspects, the multiple PUCCH resources are determined based at least in part on a configuration of a plurality of sets of PUCCH resources, wherein the plurality of sets of PUCCH resources are configured by a radio resource control protocol.

In a fourth aspect, alone or in combination with one or more of the first through third aspects, process 700 includes identifying a set of PUCCH resources from the plurality of sets of PUCCH resources based at least in part on a payload size of the uplink communication.

In a fifth aspect, alone or in combination with one or more of the first through fourth aspects, a set of PUCCH resources of the plurality of sets of PUCCH resources indicates one or more PUCCH resource clusters.

In a sixth aspect, alone or in combination with one or more of the first through fifth aspects, a PUCCH resource cluster of the one or more PUCCH resource clusters indicates one or more PUCCH resources.

In a seventh aspect, alone or in combination with one or more of the first through sixth aspects, process 700 includes identifying a PUCCH resource cluster from the one or more PUCCH resource clusters based at least in part on a PUCCH resource indicator.

In an eighth aspect, alone or in combination with one or more of the first through seventh aspects, process 700 includes identifying a PUCCH resource cluster from the one or more PUCCH resource clusters based at least in part on at least one of: a PUCCH resource indicator, a first control channel element index of a downlink communication indicating the PUCCH resource indicator, or a quantity of control channel element indexes indicated in a control resource set in which the downlink communication indicating the PUCCH resource indicator is received.

In a ninth aspect, alone or in combination with one or more of the first through eighth aspects, process 700 includes identifying a PUCCH resource cluster from the one or more PUCCH resource clusters, wherein the PUCCH resource cluster indicates the multiple PUCCH resources, wherein transmitting the one or more of the multiple repetitions of the uplink communication comprises: transmitting the one or more of the multiple repetitions using the multiple PUCCH resources indicated by the PUCCH resource cluster.

In a tenth aspect, alone or in combination with one or more of the first through ninth aspects, process 700 includes receiving an activation command to activate a first spatial relation for a first PUCCH resource of the multiple PUCCH resources and to activate a second spatial relation for a second PUCCH resource of the multiple PUCCH resources, wherein transmitting the one or more of the multiple repetitions of the uplink communication comprises: transmitting the one or more of the multiple repetitions of the uplink communication using the first PUCCH resource and the second PUCCH resource.

In an eleventh aspect, alone or in combination with one or more of the first through tenth aspects, the activation command is received via a medium access control control element (MAC-CE).

In a twelfth aspect, alone or in combination with one or more of the first through eleventh aspects, process 700 includes identifying a first PUCCH resource of the multiple PUCCH resources having a first closed loop index value; identifying a second PUCCH resource of the multiple PUCCH resources having a second closed loop index value; and receiving a downlink communication indicating a transmit power control (TPC) command.

In a thirteenth aspect, alone or in combination with one or more of the first through twelfth aspects, process 700 includes applying the TPC command to the first closed loop index value; and applying the TPC command to the second closed loop index value, wherein transmitting the one or more of the multiple repetitions of the uplink communication comprises: transmitting the one or more of the multiple repetitions of the uplink communication using the first PUCCH resource and the second PUCCH resource based at least in part on applying the TPC command to the first closed loop index value and applying the TPC command to the second closed loop index value.

In a fourteenth aspect, alone or in combination with one or more of the first through thirteenth aspects, process 700 includes applying the TPC command to the first closed loop index value, wherein transmitting the one or more of the multiple repetitions of the uplink communication comprises: transmitting the one or more of the multiple repetitions of the uplink communication using the first PUCCH resource and the second PUCCH resource based at least in part on applying the TPC command to the first closed loop index value.

In a fifteenth aspect, alone or in combination with one or more of the first through fourteenth aspects, process 700 includes identifying a first PUCCH resource of the multiple PUCCH resources having a first closed loop index value; identifying a second PUCCH resource of the multiple PUCCH resources having a second closed loop index value; receiving a downlink communication indicating a first TPC command and a second TPC command; applying the first TPC command to the first closed loop index value; and applying the second TPC command to the second closed loop index value, wherein transmitting the one or more of the multiple repetitions of the uplink communication comprises: transmitting the one or more of the multiple repetitions of the uplink communication using the first PUCCH resource and the second PUCCH resource based at least in part on applying the first TPC command to the first closed loop index value and applying the second TPC command to the second closed loop index value.

In a sixteenth aspect, alone or in combination with one or more of the first through fifteenth aspects, receiving a downlink communication indicating the first TPC command and the second TPC command comprises: identifying a first field in the downlink communication indicating the first TPC command, and identifying a second field in the downlink communication indicating the second TPC command.

In a seventeenth aspect, alone or in combination with one or more of the first through sixteenth aspects, receiving the downlink communication indicating the first TPC command and the second TPC command comprises: identifying a field in the downlink communication indicating the first TPC command and the second TPC command.

In an eighteenth aspect, alone or in combination with one or more of the first through seventeenth aspects, process 700 includes determining whether to drop one or more of the multiple repetitions of the uplink communication based at least in part on a determination that one or more of the multiple PUCCH resources associated with the uplink communication overlaps in a time domain with at least one other PUCCH resource of a different uplink communication.

In a nineteenth aspect, alone or in combination with one or more of the first through eighteenth aspects, process 700 includes comparing an uplink communication type of the uplink communication to an uplink communication type of the different uplink communication; and dropping the uplink communication or the different uplink communication based at least in part on comparing the uplink communication types.

In a twentieth aspect, alone or in combination with one or more of the first through nineteenth aspects, process 700 includes comparing a starting time of the one or more of the multiple repetitions of the uplink communication to a starting time of the different uplink communication; and dropping the one or more of the multiple repetitions of the uplink communication or the different uplink communication based at least in part on comparing the starting times.

In a twenty-first aspect, alone or in combination with one or more of the first through twentieth aspects, process 700 includes comparing a quantity of repetitions of the one or more of the multiple repetitions of the uplink communication in the single slot to a quantity of repetitions of the different uplink communication in the single slot; and dropping the one or more of the multiple repetitions of the uplink communication or the different uplink communication based at least in part on comparing the quantity of repetitions.

In a twenty-second aspect, alone or in combination with one or more of the first through twenty-first aspects, process 700 includes determining that one or more of the multiple PUCCH resources overlaps in a time domain with at least one physical uplink shared channel (PUSCH) resource of an associated different uplink communication; and dropping the different uplink communication based at least in part on determining that one or more of the multiple PUCCH resources overlaps in the time domain with the at least one PUSCH resource.

In a twenty-third aspect, alone or in combination with one or more of the first through twenty-second aspects, process 700 includes determining whether to multiplex one or more of the multiple repetitions of the uplink communication with one or more different uplink communications, based at least in part on a determination that the one or more different uplink communications are scheduled in one or more resources that overlap in a time domain with at least one of the multiple PUCCH resources.

In a twenty-fourth aspect, alone or in combination with one or more of the first through twenty-third aspects, process 700 includes determining that the one or more resources that overlap in the time domain with at least one of the multiple PUCCH resources are one or more PUCCH resources; multiplexing, based at least in part on determining that the one or more resources that overlap in the time domain with at least one of the multiple PUCCH resources are PUCCH resources, the uplink communication with the one or more different uplink communications; and transmitting the uplink communication and the one or more different uplink communications using the one or more of the multiple PUCCH resources, or one or more other resources.

In a twenty-fifth aspect, alone or in combination with one or more of the first through twenty-fourth aspects, process 700 includes determining that the one or more resources that overlap in a time domain with at least one of the multiple PUCCH resources are one or more resources for a PUSCH transmission; determining that the PUSCH transmission includes multiple PUSCH repetitions; and multiplexing, based at least in part on determining that the PUSCH transmission includes multiple PUSCH repetitions, the uplink communication with the multiple PUSCH repetitions.

In a twenty-sixth aspect, alone or in combination with one or more of the first through twenty-fifth aspects, process 700 includes determining that the one or more resources that overlap in a time domain with at least one of the multiple PUCCH resources are for a PUSCH transmission; determining that the PUSCH transmission includes multiple PUSCH repetitions; multiplexing, based at least in part on determining that the PUSCH transmission includes multiple PUSCH repetitions, the uplink communication with the one or more PUSCH repetitions that overlap in the time domain with at least one of the multiple PUCCH resources; and transmitting the one or more repetitions of the uplink communication that do not overlap in the time domain with any of the PUSCH repetitions using associated PUCCH resources.

In a twenty-seventh aspect, alone or in combination with one or more of the first through twenty-sixth aspects, process 700 includes determining that the one or more resources that overlap in a time domain with at least one of the multiple PUCCH resources are for a PUSCH transmission; determining that the PUSCH transmission includes multiple PUSCH repetitions; and dropping, based at least in part on determining that the PUSCH transmission includes multiple PUSCH repetitions, the one or more of the multiple repetitions of the uplink communication.

In a twenty-eighth aspect, alone or in combination with one or more of the first through twenty-seventh aspects, process 700 includes determining that the one or more resources that overlap in a time domain with at least one of the multiple PUCCH resources are for a PUSCH transmission; determining that the PUSCH transmission includes multiple PUSCH repetitions; and dropping, based at least in part on determining that the PUSCH transmission includes multiple PUSCH repetitions, the one or more repetitions of the uplink communication associated with the at least one of the multiple PUCCH resources that overlap in the time domain with the one or more PUSCH repetitions.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with various aspects of the present disclosure. Example process 800 is an example where the base station (e.g., base station 110 and/or the like) performs operations associated with uplink communication repetition in a single slot using multiple uplink control channel resources.

As shown in FIG. 8, in some aspects, process 800 may include determining multiple PUCCH resources in a single slot that are to be used for multiple repetitions of an uplink communication of a UE (block 810). For example, the base station (e.g., using transmit processor 220, receive processor 238, controller/processor 240, memory 242, and/or the like) may determine multiple PUCCH resources in a single slot that are to be used for multiple repetitions of an uplink communication of a UE, as described above.

As further shown in FIG. 8, in some aspects, process 800 may include transmitting, to the UE, an indication of the multiple PUCCH resources, to enable the UE to transmit one or more of the multiple repetitions using one or more of the multiple PUCCH resources, or one or more other resources, in the same slot (block 820). For example, the base station (e.g., using transmit processor 220, receive processor 238, controller/processor 240, memory 242, and/or the like) may transmit, to the UE, an indication of the multiple PUCCH resources, to enable the UE to transmit one or more of the multiple repetitions using one or more of the multiple PUCCH resources, or one or more other resources, in the same slot, as described above.

Process 800 may include additional aspects, such as any single aspect or any combination of aspects described below and/or in connection with one or more other processes described elsewhere herein.

In a first aspect, the multiple PUCCH resources are time division multiplexed.

In a second aspect, alone or in combination with the first aspect, the multiple PUCCH resources overlap in a time domain.

In a third aspect, alone or in combination with one or more of the first and second aspects, transmitting, to the UE, the indication of the multiple PUCCH resources comprises transmitting a configuration of a plurality of sets of PUCCH resources.

In a fourth aspect, alone or in combination with one or more of the first through third aspects, process 800 includes configuring the plurality of sets of PUCCH resources using a radio resource control protocol; and identifying a set of PUCCH resources from the plurality of sets of PUCCH resources based at least in part on a payload size of the uplink communication.

In a fifth aspect, alone or in combination with one or more of the first through fourth aspects, the set of PUCCH resources indicates one or more PUCCH resource clusters.

In a sixth aspect, alone or in combination with one or more of the first through fifth aspects, a PUCCH resource cluster of the one or more PUCCH resource clusters indicates one or more PUCCH resources.

In a seventh aspect, alone or in combination with one or more of the first through sixth aspects, process 800 includes identifying a PUCCH resource cluster from the one or more PUCCH resource clusters based at least in part on a PUCCH resource indicator.

In an eighth aspect, alone or in combination with one or more of the first through seventh aspects, process 800 includes identifying a PUCCH resource cluster from the one or more PUCCH resource clusters based at least in part on at least one of: a PUCCH resource indicator, a first control channel element index of a downlink communication indicating the PUCCH resource indicator, or a quantity of control channel element indexes is indicating in a control resource set in which the downlink communication indicating the PUCCH resource indicator is transmitted.

In a ninth aspect, alone or in combination with one or more of the first through eighth aspects, process 800 includes identifying a PUCCH resource cluster from the one or more PUCCH resource clusters, wherein the PUCCH resource cluster indicates the multiple PUCCH resources; and receiving the one or more of the multiple repetitions using the multiple PUCCH resources indicated by the PUCCH resource cluster

In a tenth aspect, alone or in combination with one or more of the first through ninth aspects, process 800 includes transmitting an activation command to activate a first spatial relation for a first PUCCH resource of the multiple PUCCH resources and to activate a second spatial relation for a second PUCCH resource of the multiple PUCCH resources; and receiving, from the UE, the one or more of the multiple repetitions of the uplink communication using the first PUCCH resource and the second PUCCH resource.

In an eleventh aspect, alone or in combination with one or more of the first through tenth aspects, the activation command is transmitted via a medium access control control element (MAC-CE).

In a twelfth aspect, alone or in combination with one or more of the first through eleventh aspects, process 800 includes identifying a first PUCCH resource of the multiple PUCCH resources having a first closed loop index value; identifying a second PUCCH resource of the multiple PUCCH resources having a second closed loop index value; and transmitting, to the UE, a downlink communication indicating a transmit power control (TPC) command.

In a thirteenth aspect, alone or in combination with one or more of the first through twelfth aspects, process 800 includes receiving, from the UE, the one or more of the multiple repetitions of the uplink communication using the first PUCCH resource and the second PUCCH resource based at least in part on enabling the UE to apply the TPC command to the first closed loop index value and to apply the TPC command to the second closed loop index value.

In a fourteenth aspect, alone or in combination with one or more of the first through thirteenth aspects, process 800 includes receiving, from the UE, the one or more of the multiple repetitions of the uplink communication using the first PUCCH resource and the second PUCCH resource based at least in part on enabling the UE to apply the TPC command to the first closed loop index value.

In a fifteenth aspect, alone or in combination with one or more of the first through fourteenth aspects, process 800 includes identifying a first PUCCH resource of the multiple PUCCH resources having a first closed loop index value; identifying a second PUCCH resource of the multiple PUCCH resources having a second closed loop index value; transmitting, to the UE, a downlink communication indicating a first TPC command and a second TPC command; and receiving, from the UE, the one or more of the multiple repetitions of the uplink communication using the first PUCCH resource and the second PUCCH resource based at least in part on enabling the UE to apply the first TPC command to the first closed loop index value and to apply the second TPC command to the second closed loop index value.

In a sixteenth aspect, alone or in combination with one or more of the first through fifteenth aspects, transmitting the downlink communication indicating the first TPC command and the second TPC command comprises: configuring a first field in the downlink communication indicating the first TPC command, and configuring a second field in the downlink communication indicating the second TPC command.

In a seventeenth aspect, alone or in combination with one or more of the first through sixteenth aspects, transmitting the downlink communication indicating the first TPC command and the second TPC command comprises configuring a field in the downlink communication indicating the first TPC command and the second TPC command.

In an eighteenth aspect, alone or in combination with one or more of the first through seventeenth aspects, process 800 includes determining whether the UE is to drop one or more of the multiple repetitions of the uplink communication based at least in part on a determination that the one or more of the multiple PUCCH resources associated with the uplink communication overlaps in a time domain with at least one other PUCCH resource of a different uplink communication.

In a nineteenth aspect, alone or in combination with one or more of the first through eighteenth aspects, process 800 includes comparing an uplink communication type of the uplink communication to an uplink communication type of the different uplink communication; and determining that the UE is to drop the uplink communication or the different uplink communication based at least in part on comparing the uplink communication types.

In a twentieth aspect, alone or in combination with one or more of the first through nineteenth aspects, process 800 includes comparing a starting time of the one or more of the multiple repetitions of the uplink communication to a starting time of the different uplink communication; and determining that the UE is to drop the one or more of the multiple repetitions of the uplink communication or the different uplink communication based at least in part on comparing the starting times.

In a twenty-first aspect, alone or in combination with one or more of the first through twentieth aspects, process 800 includes comparing a quantity of repetitions of the one or more of the multiple repetitions of the uplink communication in the single slot to a quantity of repetitions of the different uplink communication in the single slot; and determining that the UE is to drop the one or more of the multiple repetitions of the uplink communication or the different uplink communication based at least in part on comparing the quantity of repetitions.

In a twenty-second aspect, alone or in combination with one or more of the first through twenty-first aspects, process 800 includes determining that one or more of the multiple PUCCH resources overlaps in a time domain with at least one physical uplink shared channel (PUSCH) resource of an associated different uplink communication; and determining that the UE is to drop the different uplink communication based at least in part on determining that one or more of the multiple PUCCH resources overlaps in the time domain with the at least one PUSCH resource.

In a twenty-third aspect, alone or in combination with one or more of the first through twenty-second aspects, process 800 includes determining whether the UE is to multiplex one or more of the multiple repetitions of the uplink communication with one or more different uplink communications, based at least in part on a determination that the one or more different uplink communications are scheduled in one or more resources that overlap in a time domain with at least one of the multiple PUCCH resources.

In a twenty-fourth aspect, alone or in combination with one or more of the first through twenty-third aspects, process 800 includes determining that the one or more resources that overlap in the time domain with at least one of the multiple PUCCH resources are one or more PUCCH resources; determining that the UE is to multiplex, based at least in part on determining that the one or more resources that overlap in the time domain with at least one of the multiple PUCCH resources are PUCCH resources, the uplink communication with the one or more different uplink communications; and receiving the uplink communication and the one or more different uplink communications using the one or more of the multiple PUCCH resources, or one or more other resources.

In a twenty-fifth aspect, alone or in combination with one or more of the first through twenty-fourth aspects, process 800 includes determining that the one or more resources that overlap in a time domain with at least one of the multiple PUCCH resources are one or more resources for a PUSCH transmission; determining that the PUSCH transmission includes multiple PUSCH repetitions; and determining that the UE is to multiplex, based at least in part on determining that the PUSCH transmission includes multiple PUSCH repetitions, the uplink communication with the multiple PUSCH repetitions.

In a twenty-sixth aspect, alone or in combination with one or more of the first through twenty-fifth aspects, process 800 includes determining that the one or more resources that overlap in a time domain with at least one of the multiple PUCCH resources are for a PUSCH transmission; determining that the PUSCH transmission includes multiple PUSCH repetitions; determining that the UE is to multiplex, based at least in part on determining that the PUSCH transmission includes multiple PUSCH repetitions, the uplink communication with the one or more PUSCH repetitions that overlap in the time domain with at least one of the multiple PUCCH resources; and receiving, from the UE, the one or more repetitions of the uplink communication that do not overlap in the time domain with any of the PUSCH repetitions using associated PUCCH resources.

In a twenty-seventh aspect, alone or in combination with one or more of the first through twenty-sixth aspects, process 800 includes determining that the one or more resources that overlap in a time domain with at least one of the multiple PUCCH resources are for a PUSCH transmission; determining that the PUSCH transmission includes multiple PUSCH repetitions; and determining that the UE is to drop, based at least in part on determining that the PUSCH transmission includes multiple PUSCH repetitions, the one or more of the multiple repetitions of the uplink communication.

In a twenty-eighth aspect, alone or in combination with one or more of the first through twenty-seventh aspects, process 800 includes determining that the one or more resources that overlap in a time domain with at least one of the multiple PUCCH resources are for a PUSCH transmission; determining that the PUSCH transmission includes multiple PUSCH repetitions; and determining that the UE is to drop, based at least in part on determining that the PUSCH transmission includes multiple PUSCH repetitions, the one or more repetitions of the uplink communication associated with the at least one of the multiple PUCCH resources that overlap in the time domain with the one or more PUSCH repetitions.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving an indication of multiple physical uplink control channel (PUCCH) resources in a single slot that are to be used for multiple repetitions of an uplink communication; and
transmitting one or more of the multiple repetitions of the uplink communication using one or more of the multiple PUCCH resources, or one or more other resources, in the single slot.

2.-3. (canceled)

4. The method of claim 1, wherein the multiple PUCCH resources are based at least in part on a configuration of a plurality of sets of PUCCH resources.

5. The method of claim 4, further comprising:
identifying a set of PUCCH resources from the plurality of sets of PUCCH resources based at least in part on a payload size of the uplink communication.

6. The method of claim 4, wherein a set of PUCCH resources of the plurality of sets of PUCCH resources indicates one or more PUCCH resource clusters.

7.-8. (canceled)

9. The method of claim 6,
wherein a PUCCH resource cluster from the one or more PUCCH resource clusters is indicated based at least in part on at least one of:
a PUCCH resource indicator,
a first control channel element index of a downlink communication indicating the PUCCH resource indicator, or
a quantity of control channel element indexes indicated in a control resource set in which the downlink communication indicating the PUCCH resource indicator is received.

10. The method of claim 6,
wherein transmitting the one or more of the multiple repetitions of the uplink communication comprises:
transmitting the one or more of the multiple repetitions using the multiple PUCCH resources indicated by a PUCCH resource cluster from the one or more PUCCH resource clusters.

11. The method of claim 1, further comprising:
receiving an activation command to activate a first spatial relation for a first PUCCH resource of the multiple PUCCH resources and to activate a second spatial relation for a second PUCCH resource of the multiple PUCCH resources,
wherein transmitting the one or more of the multiple repetitions of the uplink communication comprises:
transmitting the one or more of the multiple repetitions of the uplink communication using the first PUCCH resource and the second PUCCH resource.

12. (canceled)

13. The method of claim 1,
wherein a first PUCCH resource of the multiple PUCCH resources having a first closed loop index value; and
wherein a second PUCCH resource of the multiple PUCCH resources has a second closed loop index value.

14. The method of claim 13, further comprising:
applying a transmit power control (TPC) command to the first closed loop index value; and
applying the TPC command to the second closed loop index value,
wherein transmitting the one or more of the multiple repetitions of the uplink communication comprises:
transmitting the one or more of the multiple repetitions of the uplink communication using the first PUCCH resource and the second PUCCH resource based at least in part on applying the TPC command to the first closed loop index value and applying the TPC command to the second closed loop index value.

15. The method of claim 13, further comprising:
applying a transmit power control (TPC) command to the first closed loop index value,
wherein transmitting the one or more of the multiple repetitions of the uplink communication comprises:
transmitting the one or more of the multiple repetitions of the uplink communication using the first PUCCH resource and the second PUCCH resource based at least in part on applying the TPC command to the first closed loop index value.

16. The method of claim 13, further comprising:
applying a first transmit power control (TPC) command to the first closed loop index value; and
applying a second TPC command to the second closed loop index value,
wherein transmitting the one or more of the multiple repetitions of the uplink communication comprises:
transmitting the one or more of the multiple repetitions of the uplink communication using the first PUCCH resource and the second PUCCH resource based at least in part on applying the first TPC command to the first closed loop index value and applying the second TPC command to the second closed loop index value.

17.-18. (canceled)

19. The method of claim 1, further comprising:
dropping one or more of the multiple repetitions of the uplink communication based at least in part on a determination that one or more of the multiple PUCCH resources associated with the uplink communication overlaps in a time domain with at least one other PUCCH resource of a different uplink communication.

20.-22. (canceled)

23. The method of claim 1, further comprising:
dropping a different uplink communication based at least in part on a determination that one or more of the multiple PUCCH resources overlaps in a time domain with at least one physical uplink shared channel resource associated with the different uplink communications.

24. The method of claim 1, further comprising:
multiplexing one or more of the multiple repetitions of the uplink communication with one or more different uplink communications, based at least in part on a determination that the one or more different uplink communications are scheduled in one or more resources that overlap in a time domain with at least one of the multiple PUCCH resources.

25.-29. (canceled)

30. A method of wireless communication performed by a base station, comprising:
transmitting an indication of multiple physical uplink control channel (PUCCH) resources in a single slot that are to be used for multiple repetitions of an uplink communication of a user equipment (UE); and
receiving one or more of the multiple repetitions using one or more of the multiple PUCCH resources, or one or more other resources, in the single slot.

31.-32. (canceled)

33. The method of claim 30, wherein the multiple PUCCH resources are:
based at least in part on a configuration of a plurality of sets of PUCCH resources.

34. (canceled)

35. The method of claim 33, wherein a set of PUCCH resources of the plurality of sets of PUCCH resources indicates one or more PUCCH resource clusters.

36.-37. (canceled)

38. The method of claim 35,
wherein a PUCCH resource cluster from the one or more PUCCH resource clusters is indicated based at least in part on at least one of:
a PUCCH resource indicator,
a first control channel element index of a downlink communication indicating the PUCCH resource indicator, or
a quantity of control channel element indexes indicated in a control resource set in which the downlink communication indicating the PUCCH resource indicator is transmitted.

39. The method of claim 35, wherein receiving the one or more of the multiple repetitions of the uplink communication comprises:
receiving the one or more of the multiple repetitions using the multiple PUCCH resources indicated by a PUCCH resource cluster from the one or more PUCCH resource clusters.

40. The method of claim 30, further comprising:
transmitting an activation command to activate a first spatial relation for a first PUCCH resource of the multiple PUCCH resources and to activate a second spatial relation for a second PUCCH resource of the multiple PUCCH resources,
wherein receiving the one or more of the multiple repetitions of the uplink communication comprises:
receiving the one or more of the multiple repetitions of the uplink communication using the first PUCCH resource and the second PUCCH resource.

41. (canceled)

42. The method of claim 30,
wherein a first PUCCH resource of the multiple PUCCH resources has a first closed loop index value, and
wherein a second PUCCH resource of the multiple PUCCH resources has a second closed loop index value.

43.-44. (canceled)

45. The method of claim 30, further comprising:
transmitting a downlink communication indicating a first transmit power control (TPC) command and a second TPC command.

46.-64. (canceled)

65. A user equipment (UE) for wireless communication, comprising:
a memory; and
one or more processors operatively coupled to the memory, the one or more processors configured to cause the UE to:
receive an indication of multiple physical uplink control channel (PUCCH) resources in a single slot that are to be used for multiple repetitions of an uplink communication; and
transmit one or more of the multiple repetitions of the uplink communication using one or more of the multiple PUCCH resources, or one or more other resources, in the single slot.

66. The UE of claim 65, wherein the multiple PUCCH resources are based at least in part on a configuration of a plurality of sets of PUCCH resources.

67. The UE of claim 66, wherein a set of PUCCH resources of the plurality of sets of PUCCH resources indicates one or more PUCCH resource clusters.

68. The UE of claim 67, wherein the one or more processors, to cause the UE to transmit the one or more of the multiple repetitions of the uplink communication, are configured to cause the UE to:
transmit the one or more of the multiple repetitions using the multiple PUCCH resources indicated by a PUCCH resource cluster from the one or more PUCCH resource clusters.

69. The UE of claim 65, wherein the one or more processors are further configured to cause the UE to:
receive an activation command to activate a first spatial relation for a first PUCCH resource of the multiple PUCCH resources and to activate a second spatial relation for a second PUCCH resource of the multiple PUCCH resources,
wherein the one or more processors, to cause the UE to transmit the one or more of the multiple repetitions of the uplink communication, are configured to cause the UE to:
transmit the one or more of the multiple repetitions of the uplink communication using the first PUCCH resource and the second PUCCH resource.

70. A base station for wireless communication, comprising:
a memory; and
one or more processors operatively coupled to the memory, the one or more processors configured to cause the base station to:
transmit an indication of multiple physical uplink control channel (PUCCH) resources in a single slot that are to be used for multiple repetitions of an uplink communication of a user equipment (UE); and
receive one or more of the multiple repetitions using one or more of the multiple PUCCH resources, or one or more other resources, in the single slot.

71. The base station of claim 70, wherein the multiple PUCCH resources are based at least in part on a configuration of a plurality of sets of PUCCH resources.

72. The base station of claim 71, wherein a set of PUCCH resources of the plurality of sets of PUCCH resources indicates one or more PUCCH resource clusters.
